(19) United States
(12) Patent Application Publication
(10) Pub. No.: US 2017/0255977 A1
(43) Pub. Date: Sep. 7, 2017

(54) SYSTEM AND METHOD FOR MARKETING AND SELLING PRODUCTS THROUGH CUSTOM OFFER CHANNELS

(71) Applicant: Grace Tang, Newark, CA (US)

(72) Inventor: Grace Tang, Newark, CA (US)

(21) Appl. No.: 15/457,512

(22) Filed: Mar. 13, 2017

Related U.S. Application Data
(63) Continuation-in-part of application No. 14/216,435, filed on Mar. 17, 2014.
Application No. 14/216,435 is a continuation-in-part of application No. 14/800,655, filed on Jul. 15, 2015.
Application No. 14/800,655 is a continuation-in-part of application No. 62/423,778, filed on Nov. 18, 2016.

(51) Int. Cl. G06Q 30/06; G06Q 30/02

(52) U.S. Cl. CPC G06Q 30/0607; G06Q 30/0643; G06Q 30/0269

(57) ABSTRACT

A system, method and process for marketing and promoting bulk made products through custom offer channels, and facilitate bulk sell of said products. Said system, method and process dynamically promote custom product offerings to consumer groups using custom offer channels, dynamically adjust the content, frequency, timeframe and etc of said promotions based on real-time consumer feedback. Said system facilitates the vendors and consumers reach agreements on the sell, optimize the selling processes and results.

This application is a continuation-in-part of application Ser. No. 14,216,435, filed Mar. 17, 2014; is also a continuation-in-part of application Ser. No. 14,800,655, filed Jul. 15, 2015, and is also a continuation-in-part of application Ser. No. 62,423,778, filed Nov. 18, 2016 by the present inventor, that are incorporated by reference.

### BACKGROUND OF THE INVENTION

1. Field of the Invention

This invention relates generally to a system and method for marketing and promoting bulk made products through custom offer channels, and facilitate bulk sell of said products.

2. Description of Prior Art

It is challenging for vendors to produce custom made products, make sales and gain profit. Price competition in the market is very severe, vendors often can only make sales at cost level. It is very different for vendors to offer high quality products and sell them at large quantity to cover their cost of making said custom made products.

At the same time, the market is congested with mass produced products, and generic advertisements. It is very difficult for consumers to find the custom products they really like, buy high quality customized products, tailored with their personal preferences. This invention offers a solution to solve this problem.

In our current market, our commerce is dominated by mass production. Mass production is created by using a unified production process, facilitated by machine, automation, 3D printing and other modern technologies, to produce products. It creates an unlimited capability to reproduce and duplicate products, fulfilling human consumption needs in this world.

Human beings have a relatively linear reproduce and/or replacement rate. Our productivity of goods has an exponential growth rate. This means our productivity will and/or has in some sectors, outpace the consumption needs of human beings.

Upon reaching optimized productivity, it is possible that all unfulfilled consumption needs could be fulfilled as needed.

This fulfillment capability, if facilitated and equipped with real-time on-demand distribution, will provides an environment where all human beings will have unlimited food to eat, unlimited commodities to use. This fulfillment capability, enabled by mass-production, will be able to fulfill all unified consumption needs in this world.

However, it also creates some serious issues.

With the exponential growth of the productivity, less and less human resource will be needed to fulfill the consumption needs in the market. One or a few entities could eventually control and handle all the productivity capability and fulfillment in the market, and dominate the market. Human resource is no longer be essential part in the production process, and becomes obsolete. In short, many people will lose their jobs.

Mass production produces unified products, and enables fulfillment for unified consumption needs in the market. It creates a flat surface where a unified productivity meets and fulfills unified consumption needs (FIG. 1). There is no space for individualism, creativity, and personal preferences. These will become variances in a unified system, causing frictions.

Strange enough, the key variance in this unified, satisfied consumption world is human beings ourselves.

We human beings are in general very similar to each other. If we look at our genes, one person is only about one percent (1%) different from another person. Yet, from this one percent variance, there are many differences between each individual person. We look different, we act differently, and we like different things. In a sense, we are miles apart from each other. We human beings are products of mass production. We are created from the same components, yet we are each made different so that we can survive, as individuals and as a specie.

Because we like different things, we choose different things to fulfill our needs, this allows us to compete for different things, and live with each other in harmony, as a society. Because we are different, each of us has our own traits, we are good at different things, and we serve each other in different ways. This allows each of us to contribute to our society, and fulfill the needs of our society as a whole.

Because we are built from the same components, mass production will fulfill some of our basic needs, such as food and commodities. But for higher level of needs, they need to be fulfilled by other individuals in our society, tailored for each person, so that we can properly serve and take care of each other. This will allow us to live with each other in harmony, as a society, and survive as a specie.

### Section 1 Custom Production

We human beings have personal preferences. This personal preference is caused by many reasons including our genes, our parents, our education, our personal experiences and etc. People like to associate with people are similar to them, forming groups of like-minded people in our society.

Custom products is to custom make products base on segmented market demand of particular kind of products, fulfilling the market consumption needs of people who have the personal preferences and desire to purchase said custom-made products.

Custom production creates the platform for instilling creativity, personal styles, personal experiences into products, meet the personal preferences of individual consumers, fulfill their desire to purchase these products.

Custom batch production allows the producers and/or makers of these products to receive sufficient profits from making and selling these products, to sustain their businesses. By running a profitable business, they can continuously serve and fulfill the needs of these individual consumers. (FIG. 1)

### Section 2 Unit Pricing

In the production process, in general, it is more profitable to make many products out of the same process, by duplicating the same prototype product. This allows efficient usage of the production process; reduce the cost of producing each individual product.

This is the reason why mass production can make more profits, and afford to sell products at a lower unit price.

For custom made products, this causes an issue. The cost of producing the prototype product, and creating the process of reproducing said custom products is high, takes a significant amount of resource, constitutes a major portion of the total cost of the producing said custom made products.

It is also difficult to market and sell said custom made products. Because said custom made products are tailored toward specific personal preferences of individual consumers. Finding the consumers who really like said products and willing to purchase said custom products, grouping them into large amount of ordering of said custom made products is very difficult. This is why big companies seldom offer custom ordering of products. Currently, smaller boutique companies are the ones that offer custom ordering of products.

### SUMMARY OF THE INVENTION

In summary, this is a system, method and process for marketing and promoting bulk made products through custom offer channels, and facilitate bulk sell of said products. Said system, method and process dynamically promote custom product offerings to consumer groups using custom offer channels, dynamically adjust the content, frequency, timeframe and etc of said promotions based on real-time consumer feedback. Said system facilitates the vendors and consumers reach agreements on the sell, optimize the selling processes and results.

### BRIEF DESCRIPTION OF THE DRAWINGS

FIG. 1 shows an illustration of the difference between unified consumption fulfillment by mass production, and bulk consumption fulfillment by custom batch production.

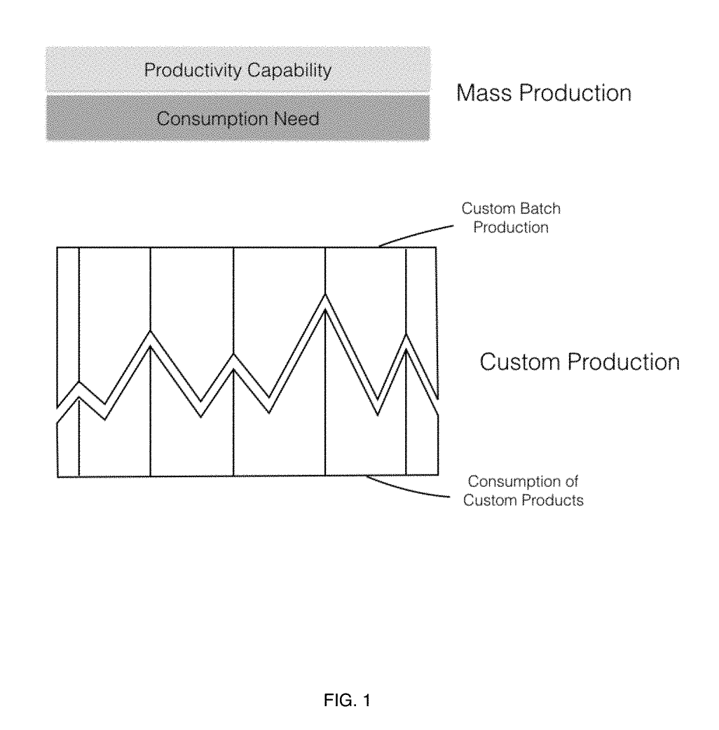

FIG. 2 is a block diagram of a custom offer system according to one embodiment of the invention.

FIG. 3 shows an illustration of unit cost of a product is reduced by increasing the amount of products being produced in the production process.

FIG. 4 shows an illustration of transaction momentum is reached between vendor and consumer by reducing the selling price to meet the purchasing price.

FIG. 5 shows an illustration of a product has multiple aspects that contribute to its final form.

FIG. 6 is a flowchart that shows a sequence of processes of a customer view the product offering, order the product through said custom offer system.

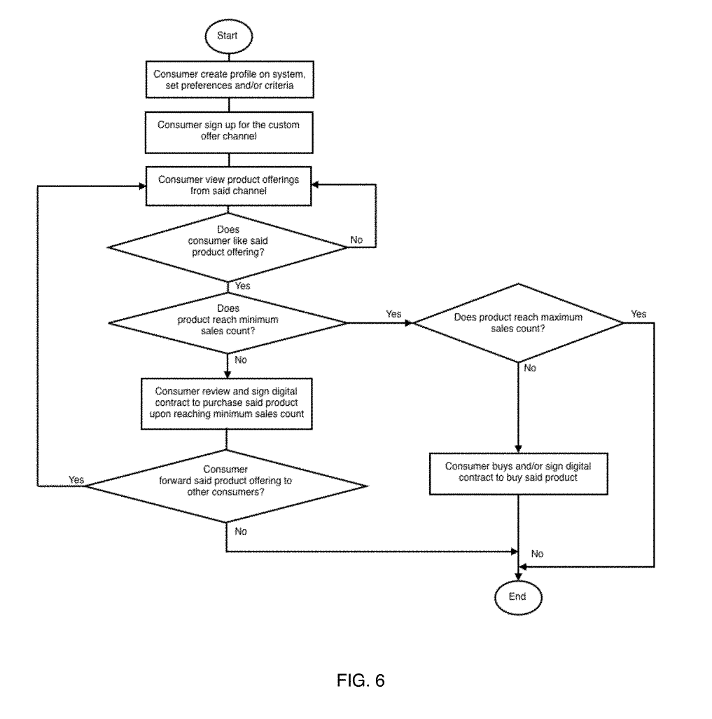

FIG. 7 shows an illustration of a product offering is being promoted on selected custom offer channels that have matching preferences, settings, and criteria; with some customers agreed to purchase said product by signing the digital contracts.

FIG. 8 shows an illustration of a product offering is being promoted on all custom offer channels in said system; with some customers agreed to purchase said product by signing the digital contracts.

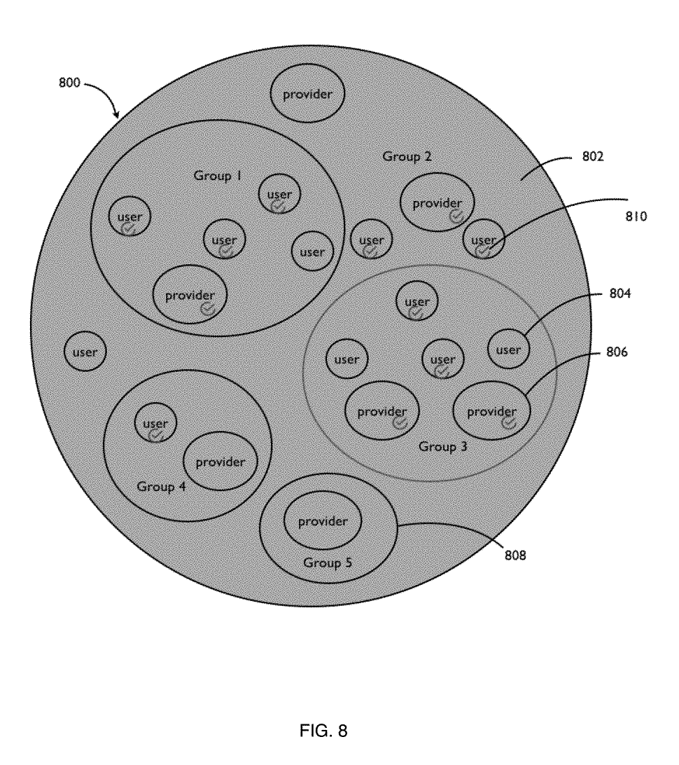

FIG. 9 shows an illustration of a product offering is being promoted in all custom offer channels in said system, upon reaching minimum sales count in said system, all digital contracts are executed, transactions of purchases and sales are completed.

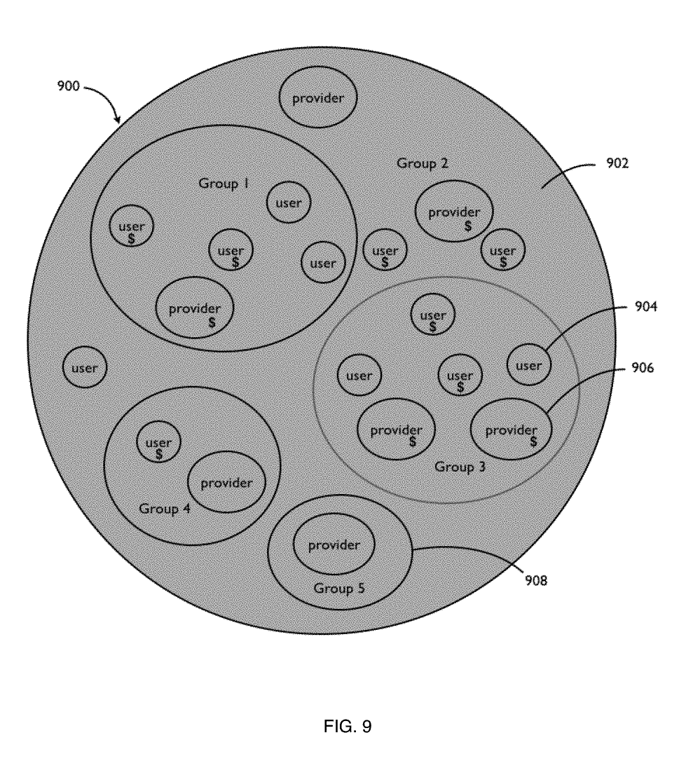

FIG. 10 shows an illustration of product offering that is under performing, get discontinued on said custom offer system.

FIG. 11 shows an illustration of a product offering reaches the minimum sales count and makes sales on said custom offer system.

FIG. 12 shows an illustration of a product offering does not reach the minimum sales count and does not make sales on said custom offer system within defined timeframe.

FIG. 13 shows an illustration of product offering reaches the minimum and maximum sales counts, and makes sales on said custom offer system.

FIG. 14 shows an illustration of calculating the unit cost and pricing of a bulk produced product.

FIG. 15 shows an illustration of a graphical user interface on consumer electronic device, let customer view the product offering and input user feedback.

FIG. 16 shows an illustration of a graphical user interface on consumer electronic device, let customer view the terms of a digital contact of a product offering and enter user input.

FIG. 17 shows an illustration of a graphical user interface on vendor electronic device, let vendor input information of his/her product offering, view and sign the digital contact.

FIG. 18 shows an illustration of a graphical user interface on vendor electronic device, let vendor input information of his/her product offering, set dynamics pricing for said product offering, view and sign the digital contact.

FIG. 19 shows an illustration increasing the frequency of promoting a product offering in a defined timeframe.

FIG. 20 shows an illustration of using an exponential equation to calculate and increase the frequency of promoting a product offering in a defined timeframe.

FIG. 21 shows an illustration of said system has a plurality of custom offer channels, continuously dispatching and distributing custom offers.

### DETAILED DESCRIPTION OF THE INVENTION

### Section 3 Mutually Acceptable Unit Pricing

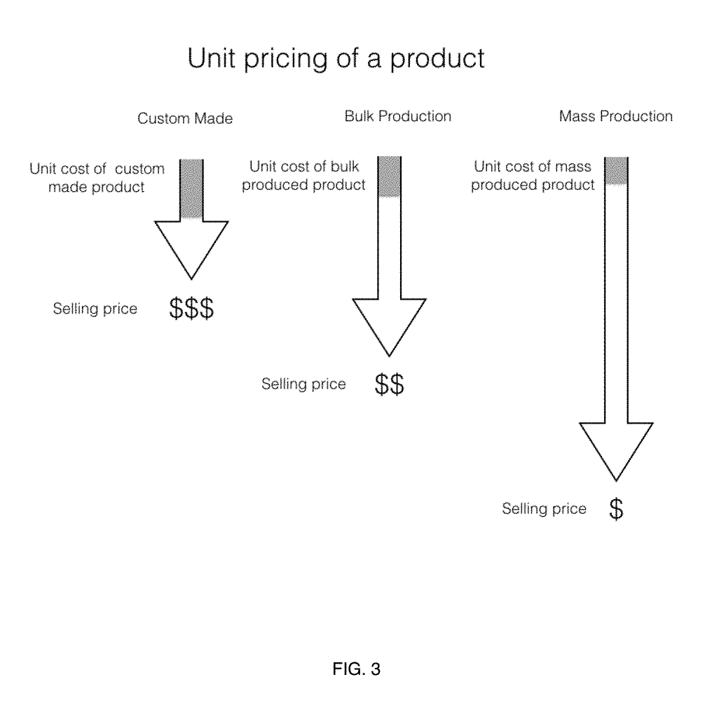

One way of lower the unit production cost of a product is increasing the amount of orderings for said products (FIG. 3).

Total cost of bulk production/Total amount of ordering =Unit production cost of product

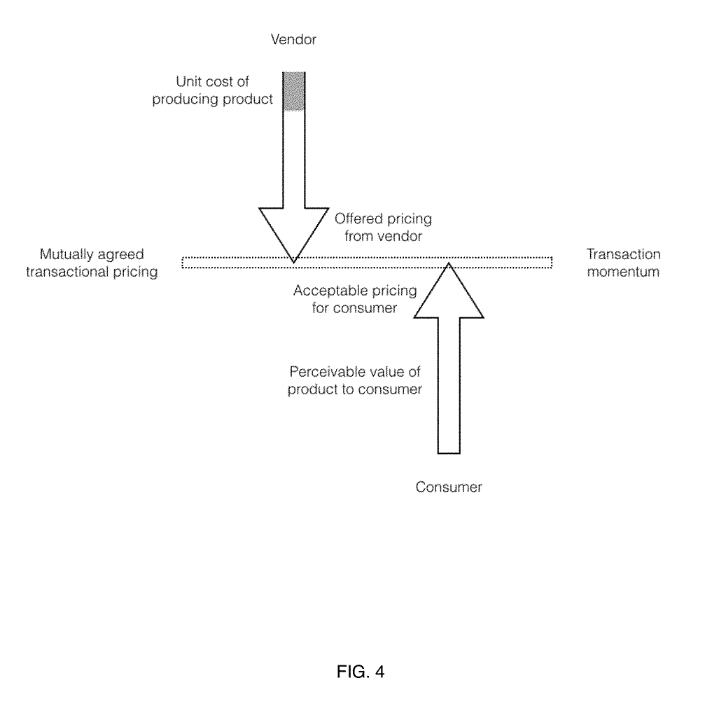

For the consumers, the acceptable pricing for them to purchase a product largely depends on the perceivable value of said product. The more they find the product tailored toward their personal preferences, the more they like the product; the more they perceive the product may improve their lives, the more likely they are willing to pay a higher price for said product (FIG. 4). The more consumers purchase said products, the higher gross sales said vendor gets for selling said product.

Gross sale of bulk produced products/Total amount of ordering=Unit price of product

The mechanism of reaching a sell of said product, at a pricing point that is acceptable by a group of consumers who like said product, as well as a pricing point where the producer/vendor can make profits out of bulking selling said products depends on increasing the amount of ordering of said product. This will lower the unit cost of the product, till it reach a mutually agreed upon transactional pricing between the vendor and the consumers, where the transaction can take place (FIG. 4). At the same time, by increasing the amount of ordering, said vendor can invest more into the prototype and production process, produce a higher quality product for said consumer, increase the perceivable value of said product in the eyes of the consumer, make them more willing to buy said custom product at a higher price.

For consumers, the perceived value of the product decides how much a consumer willing to pay said product. The more the customer like the product, the more value that said customer believe said product will bring to his/her life, the more likely said customer is willing to pay for said product.

The transaction took place when a balance and/or equivalence is reached between the money value of the product, reflected in the pricing of said product; and the perceivable value of said product, supported by the quality of said product (FIG. 4).

The art of making sales is to find the optimal point where the unit pricing of said product is lowered to meet the highest acceptable pricing said customer is willing to pay for said product. This will enable the vendor to get profit from the sell, and enable the consumer to purchase higher quality goods that brings more perceivable value to his/her life.

In the next generation market, the success of a business is to find the balance between production and consumption, at an optimal pricing that is mutually acceptable to the vendor and the consumer.

### Section 4 Transaction Momentum

Consumer's purchase intention varies from time to time. For multiple consumers to maintain the purchase intent for a custom made product, and their decisions to purchase, the transactions have to be facilitated and completed in a relatively short timeframe. This transaction momentum are kept and maintained in said system described in this invention as timeframes, in some aspects, promotional timeframe in the custom offer channel. (FIG.

### Section 5 Product Selection and Adjustment

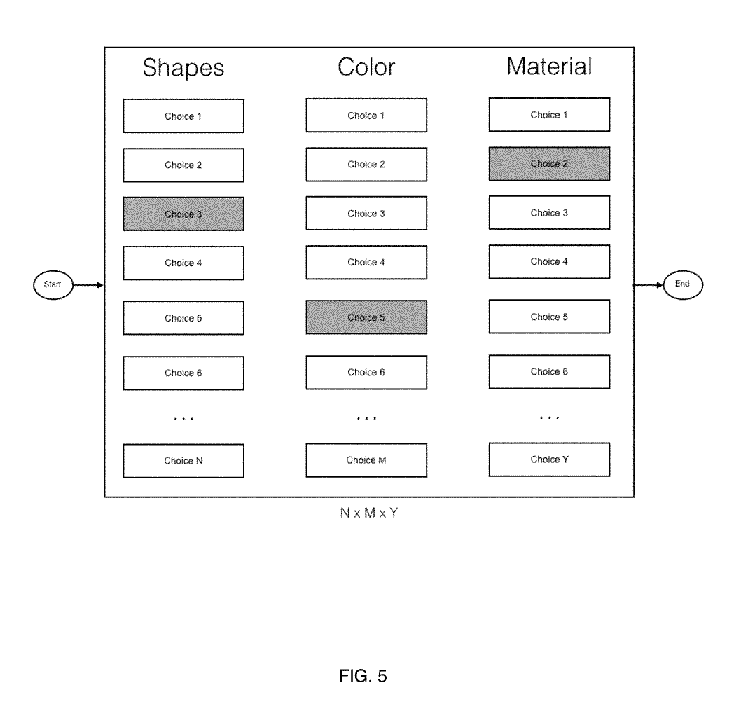

A product has multiple aspects that contribute to its final form. The color, shape, material, structure, surface texture and etc are among these aspects. (FIG. 5). To find out what combination from these aspects produces a best result, rendering a final product that are liked by many consumers, generating largest amount of sales, requires the vendors to have the expertise, refined taste, creativity and years of experience in the field. It also requires marketing tools like the one described in this invention.

It is like a pianist playing different tunes on a piano, trying to find the perfect tune most delightful for the audience. This invention is both the piano as well as the radio station, that helps product makers to define and adjust their custom made products based on consumers' real-time feedback, and facilitate the sell of these products when they reach the threshold predefined by the product maker, allow them to make bulk sell of custom made products and gain profits out of the sale.

This invention will also help the consumers receive a diverse spectrum of creative custom made products, find the ones they really like and make the purchase at a price acceptable for them.

This invention helps maintain a diverse, creative, energetic commerce market, where creative products makers are rewarded for providing high quality, creative products tailored towards individual consumer's needs, and businesses of all sizes can prosper in this market.

### Section 6 Customized Promotional Data Channel

A custom offer channel is a bundle of information of an offering of a potential product and/or service that could be fulfilled upon ordering by the consumer. It includes images, graphic, data, url links that are related to said potential product that are being promoted. It helps consumers to review, visualize and select custom products base on their personal preferences. This helps to consumers to find and buy the products they really like. This also helps the vendors to make products on-demand, based on consumer feedback.

The vendor offers digital copies of options of product offerings, present said product offerings to consumers using said custom offer channel, consumers pick out the ones they want to buy. Upon receiving sufficient amount of orderings of said product, the purchase and sales agreements are reached, vendor fulfill the ordering of said customized products, and deliver the completed product to said consumers.

### Section 7 Customized Virtual Outfit Product Promotion Data Channel

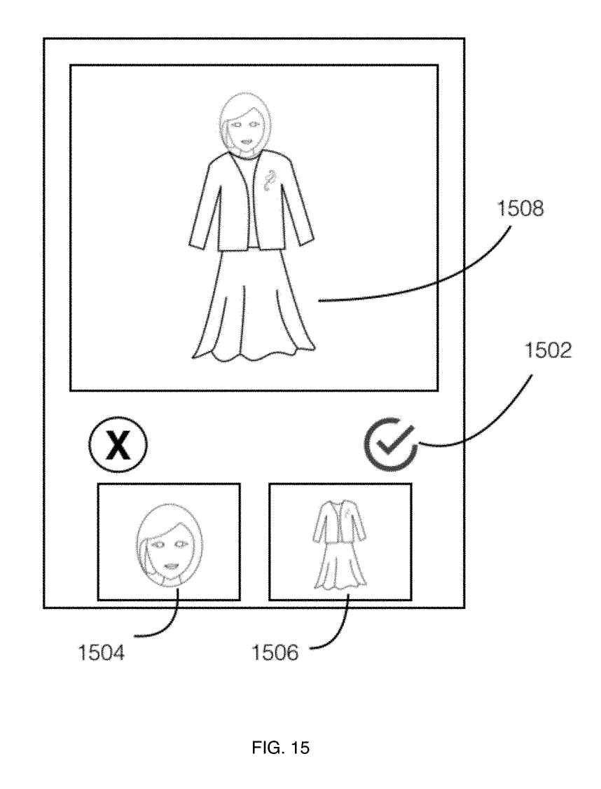

A customized virtual outfit product promotion data channel is a custom offer channel that directly render computer generated visual graphical images 1508 of new potential products 1506, situated on top of personal photo images of consumers 1504. Said visual graphical image/result is automatically generated by computer and/or electronic devices, based on the images, graphic, data, url links received from said custom offer channel, integrated with pictures and/or photos taken from the camera, and/or uploaded onto said electronic devices (FIG. 15). It let consumers visualize how a product fits into their personal environment, and/or how they look like wearing a custom made apparel product 1506.

### Section 8 Data Feed Using Customized Product Promotion Data Channel

A consumer will be able to receive a continuous feed of images, graphic, data, url links and etc using customized product promotion data channel. Said data feed is dynamically changed based on the promotions and/or information currently available on the market. Upon consumer sign up to a specific data channel, he/she will instantly be able to receive the latest promotions of current and/or future product offering on the market on their personal electronic devices.

Said system is like a pianist is playing the piano at a radio station. He/she changes his/her tunes from time to time. Consumers turn on their client programs on their personal electronic devices, listen to the tunes, choose and vote for the tunes they like best. These votes are instantly returned to the radio system. When a certain tune receives enough votes, it wins and gets to be composed and completed into the final music album. The radio station let different pianist play different tunes at different timeframes. It also serves different radio channels tailored towards the tastes of different audience groups. Consumers sign up and choose different radio channels to listen to, based on their personal preferences.

This invention describes the marketing and promotional system (radio system) for custom made future products (tunes). Consumers sign up to the custom promotion channel (radio channel) based on their personal preferences. Vendors (pianist) offers a variety of potential custom made products (tunes) on said system (radio system), and get real-time market feedback regarding the market fit of said products based on the number of pre-orders and/or votes they received from said system (votes). Said system constantly changes the product offerings and promotional messages (tunes), promote product offerings from different vendors (pianists), host different custom data channels (radio channels), helping vendors offering a diverse spectrum of products (tunes) to the market. Said system helps vendors define and refine their final sellable products (music albums), facilitate the pre-ordering and the sell of these products, helping complete bulk ordering and transaction of said products (music albums).

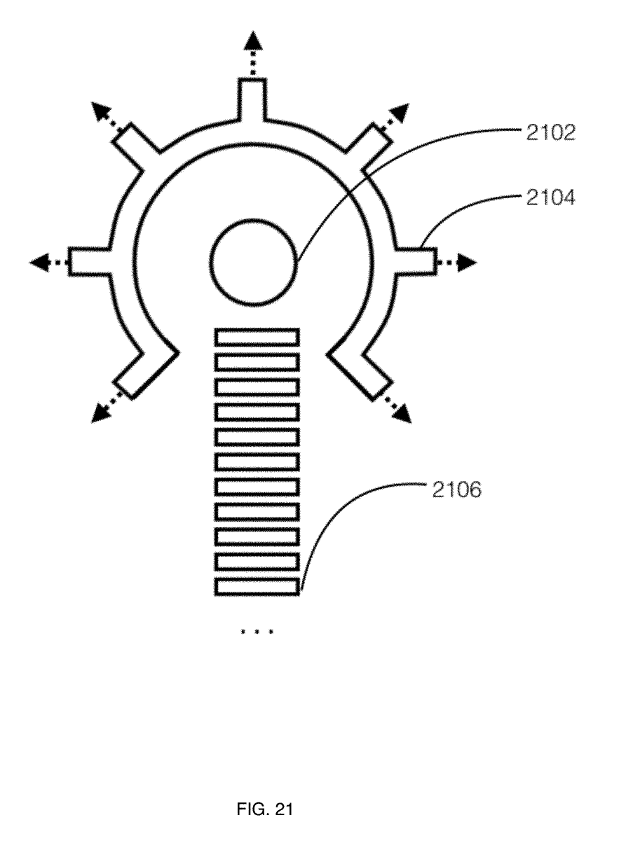

As shown in FIG. 21, said custom offer system has a plurality of custom offer channels 2104, each tailored toward the preferences of different groups of consumers. A plurality of product offerings 2106 is waiting to be dispatched and/or distributed by said system. Based on analysis of real-time consumer feedback and/or related data, said system using its algorithm 2102 to analysis and dynamically configure settings including frequency, channels and etc, to dispatch and distributing said product offering, optimizing its sales result.

### Section 9 Market Listening Mechanism

For said system to facilitate a fair opportunity for all vendors to get visibility for their potential products, it is important to maintain a dynamic, fresh new custom product offerings stream on the market. Product offerings that are not liked by consumers, offerings that are not likely to become trendy products are quickly removed from said system as soon as votes from read-time consumer feedback indicate that result.

As shown in FIG. 5, a product offering is defined by many choices by its shape, color, material, texture and etc. It is far better off for said vendor to redesign and create an improved new product offering, based on real-time market feedback, and promoting said new product offering to the market; than wasting their effort trying to promote the earlier product that most likely could not render bulk sell in the market.

Removing non-performing product offerings from the promotion channels also prevents said system from being congested with old, non-selling product offerings. This will allow said system always offering fresh, new product offerings on the channels (playing new tunes on the radio channels), and facilitate a diverse, dynamic, energetic market.

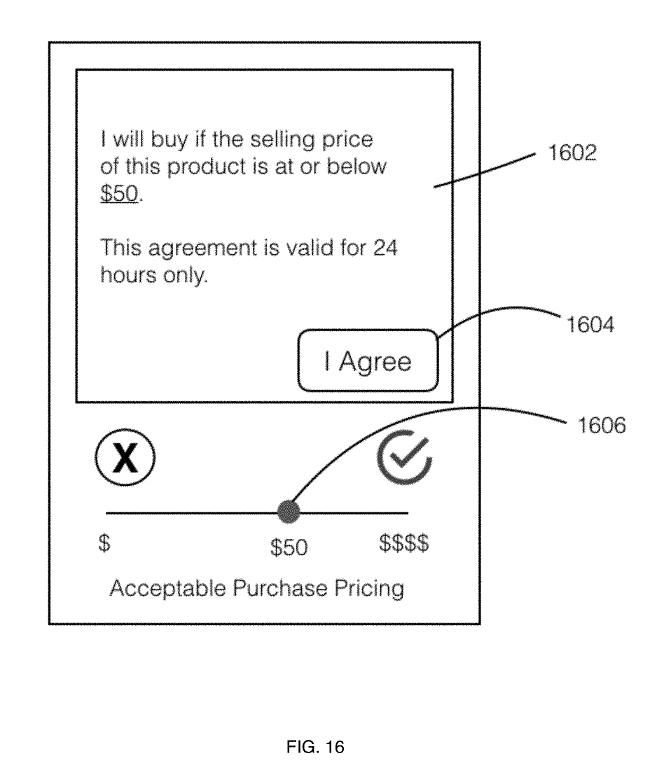

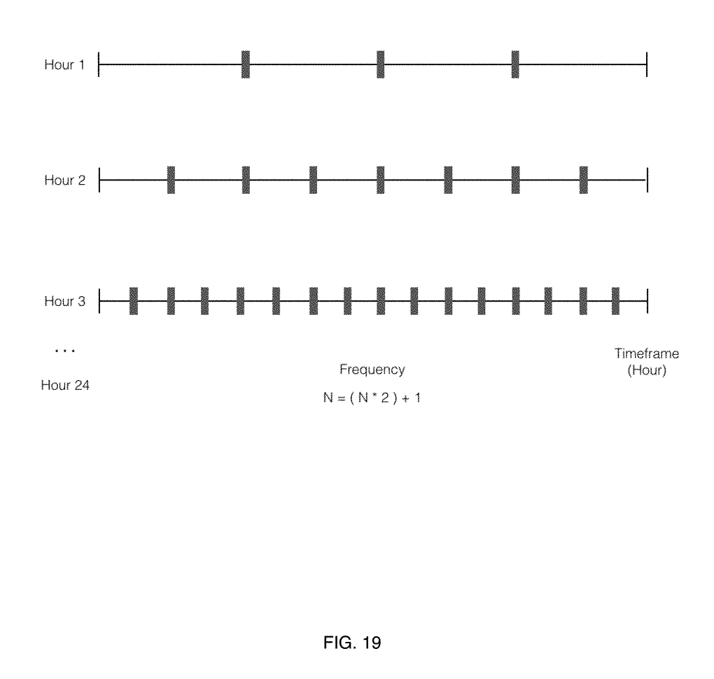

Different mechanisms can be used to maintain this dynamic flow. FIG. 19 illustrated one way to implement this mechanism. As shown in FIG. 19, a product offering was initially promoted three times for the first hour within a 24 hour timeframe. Said system promotes said product offerings among the custom data channels for audiences and/or users who are looking for said kind of products. Among 10,000 users who signed up for said data channels, 1,000 users viewed said product offering on their personalized data channels, using their personal devices (FIG. 15). Among them, 21 users like said product offerings, and willing to purchase said product, and clicked the yes checkmark 502 on their electronic devices (FIG. 15), review and sign the digital contact 1602 to purchase said product under defined terms (FIG. 16). Said system received said user feedback in real-time. Said system analysis the data, and finds 21 orderings out of 1000 views (2.1%) is above the benchmark for said product promotion. The next hour, said product offering automatically is reset to display more times on said promotional channels.

In FIG. 19, for every hour that the product offering performs above the benchmark, said product get to shown N=(N*2)+1 times the next hour. The equation and mechanism to set the benchmarks, increase the frequency, and the timeframes used to display the product offerings vary based on the type and characteristics of said product offerings.

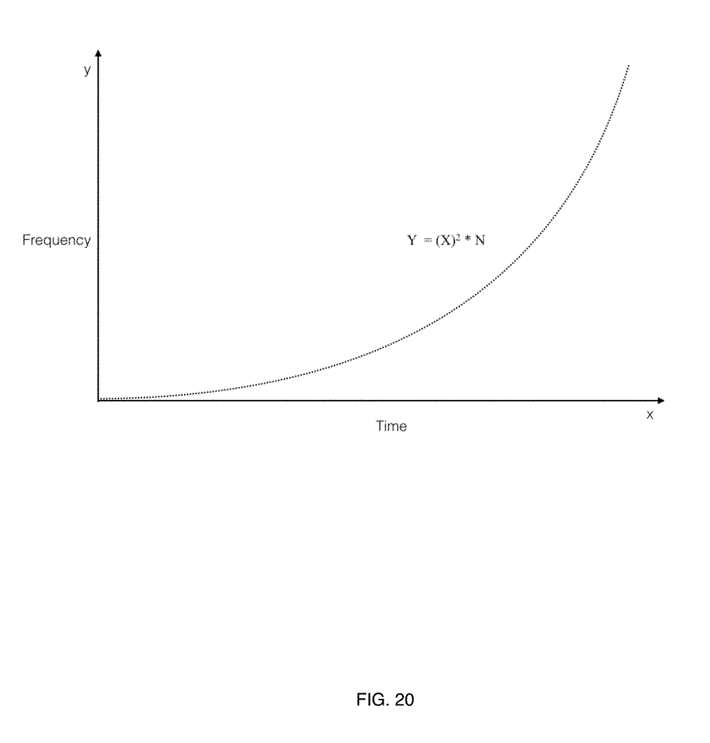

In FIG. 20, a derivative curve is used to introduce a product offering into the market at a lower frequency, wait for it to pick up some sales momentum in the market, then give it an exponential increase in the frequency to maximize its opportunity to reach minimum sales count at later part in the promotion timeframe.

Y=(X)²*N

This helps rending a market consonance on a product offering, in other words, creating a viral effect in the market for said product offering, rendering a optimal product sales result for said product.

### Section 10 Bulk Sell Benefit

For each business to make profit and sustain the business, the unit economy needs to work. In general, by producing large quantity of the same product, business can use the mechanism to reduce the production cost of each individual product. So that by producing and selling a large quantity of the same product, business owners can make profit in general, even through the unit selling price of each product may be relatively low.

On the other hand, for a business to make profit, it needs to have the capability to bulk produce and sell products on-demand, at a price that is acceptable by the consumers. Preferably, this could be the highest price that this acceptable for a consumer for said product.

### Section 11 Minimum Sales Count

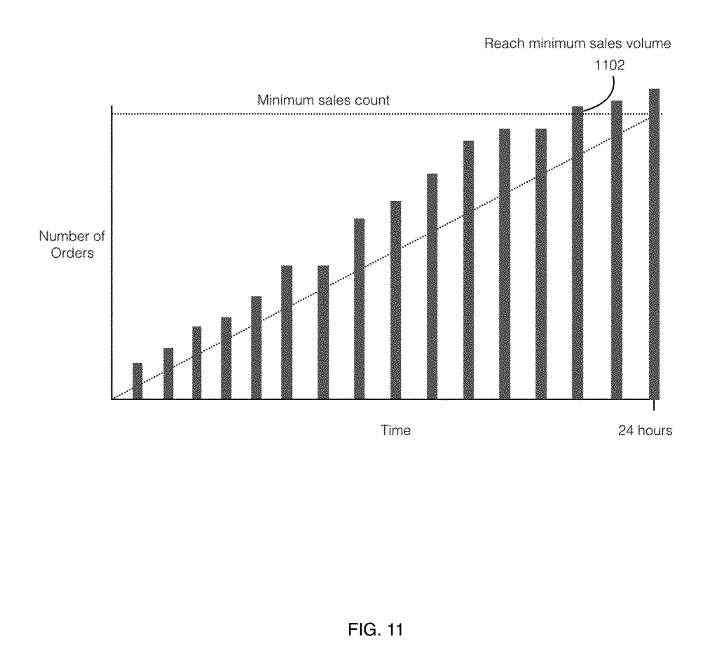

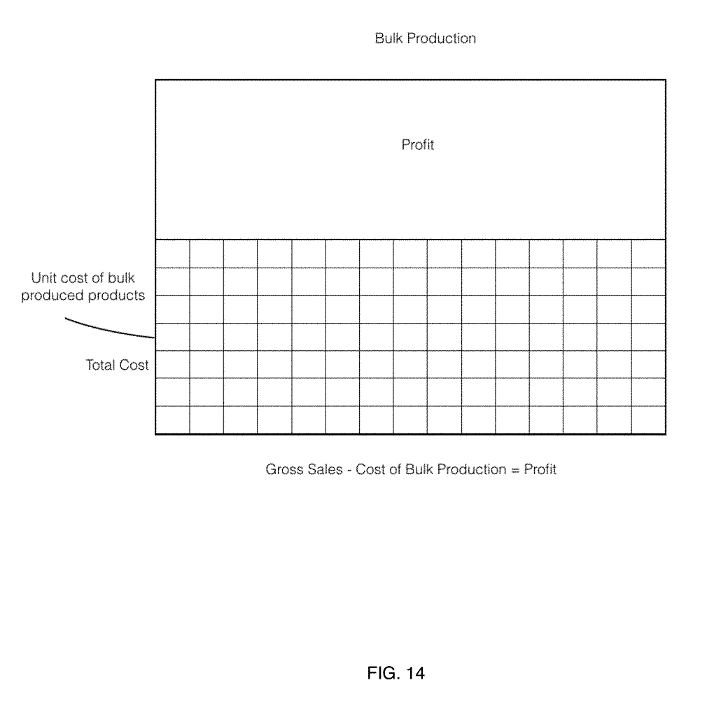

The vendor has calculated that to receive sufficient profit from bulk producing a custom made product, he/she needs to receive at least 105 orders of said products (FIG. 14). As shown in FIG. 11, By the 14^{th} hour of promoting said product offering on said system, said system have already received 105 orderings for said product, reach the minimum bulk sale benchmark. At this point of time, the potential product offering automatically becomes a real product sales agreement. Vendor is responsible to fulfill said product orderings, complete and deliver the products to consumers.

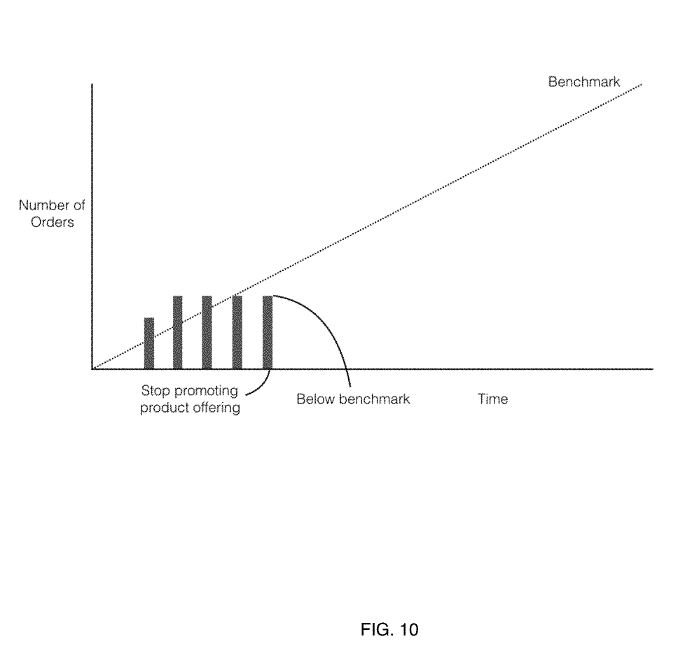

As shown in FIG. 10, another product offering is promoted on said system. By the 5^{th} hour that it is promoted on said system, the real-time market feedback shows that said product offering is performing below the defined benchmark, and unlikely to reach the minimum bulk order count in the defined timeframe (for example, 24 hours). Said product offering is immediately removed from said promotional channels. The feedback from the market is sent to the vendor who offered said product offering, for he/she to redesign and improve his/her product.

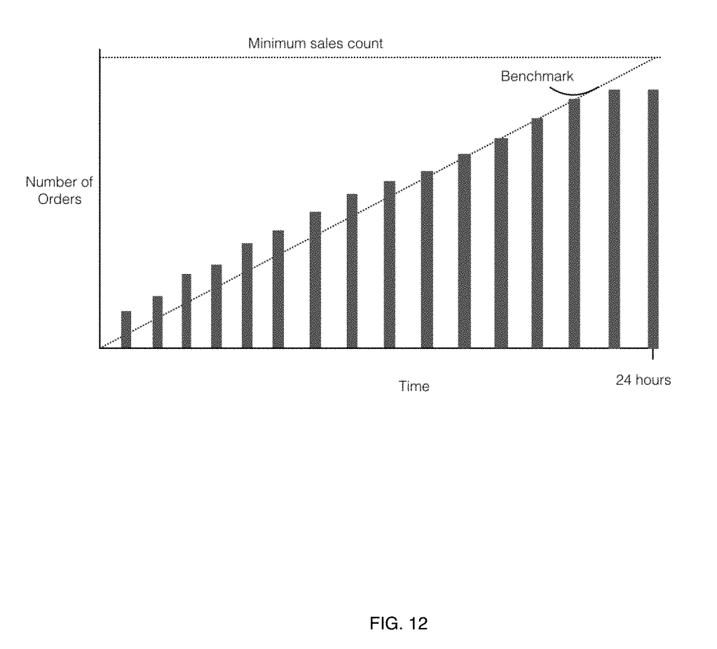

In FIG. 12, it shows another product offering. Although said product offering passes the benchmark in the earlier hours, but fail to reach the momentum to reach the minimum bulk sales count in the defined timeframe of 24 hours. Said product offering is removed from said system, all preorders and/or digital contracts are canceled and/or expired after the timeframe. Said vendor receives consumers' feedback from said system, improves his/her product, and promote said improved product on said system on another day.

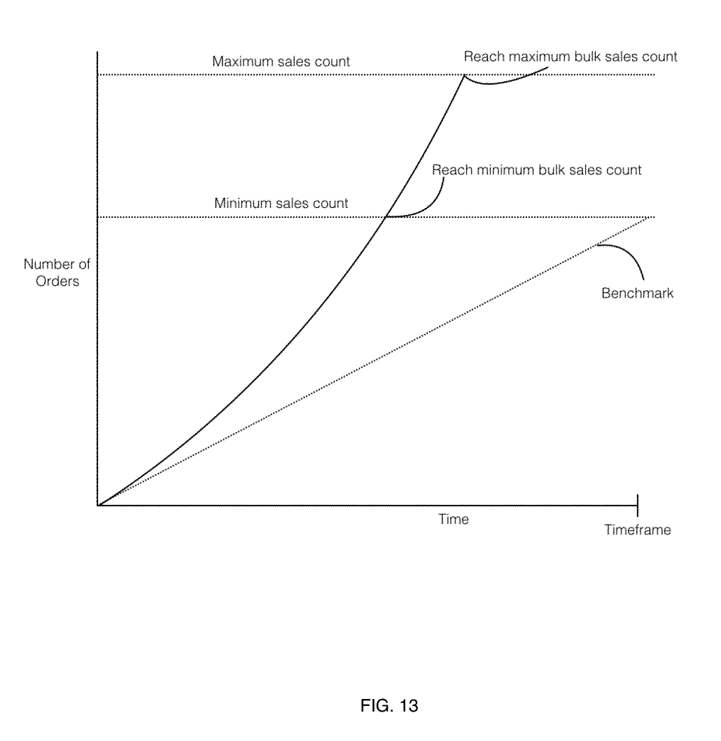

FIG. 13 shows another product offering quickly gain market favor, and reach the minimum bulk ordering count soon after being promoted on the data channels. Then it reaches the maximum bulk ordering count. Said product offering is then pulled from the promotional channels. Said vendor receives the orderings from the customers, complete the sales agreement, fulfill these orderings, and deliver the finished goods to the customers.

### Section 12 Digital Contracts

Consumer's purchase intents vary from time to time. For multiple consumers to maintain their purchase intents for a custom made product, and their decisions to purchase, the transaction has to be facilitated and completed in a relatively short timeframe. A digital contract is used to maintain the agreement of a consumer agree to purchase a product with predefined conditions, and the agreement of the vendor to offer said product with defined terms and conditions, within a limited timeframe.

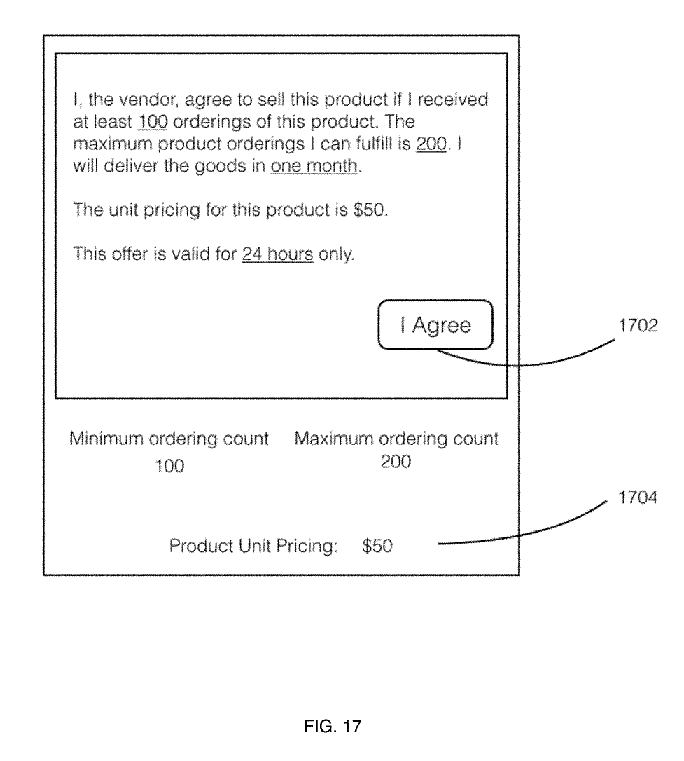

As shown in FIG. 17, a vendor agrees to sell a product at a unit price of $50 upon receiving at least 100 ordering of said product 1704. He/she enters the terms of his product offering, along with the images, photos, data, url links and etc associated with said product on said system. Said system automatically construct a digital contract, using a legal template specifically created for said type of product transaction, by filling in the terms defined by said vendor. Said vendor reviews the digital contract, and signed the contract 1702.

Upon receiving signed copy of said digital contract, along with images, photos, data, url links and etc associated with said product offering, said system starts promoting said product offering on the custom offer channel(s) of said system.

As shown in FIG. 15, a consumer receives said product offering on his/her digital device, he/she review the information and like the product. He/she clicks the yes checkmark 1502. Said system automatically displays the pricing and terms of said product offering 1602 on said graphical interface of said digital device FIG. 16. Said consumer uses the slider 1606 and indicated that he/she is willing to buy said product at a price of $50 each.

Said system automatically creates a digital contract using a legal template specifically created for this type of product transaction. Said consumer reviews the terms of the digital contract 1602, and signs the agreement 1604.

This transaction momentum are kept and maintained in the system within said agreed upon timeframe. In FIGS. 16, 17 and 18, said agreements are maintained and valid for 24 hours 1602 1702.

If said product offering reached the minimum bulk ordering count 1102 (FIG. 11), the product offering is automatically transferred into sales orders. The digital contracts of both the consumers and the vendor instantly get executed, and the digital contracts become valid purchase and sale agreements. The orders are being charged from consumers' accounts, and/or invoiced to consumers' accounts. The vendor receives the signed contracts from the consumers, and/or the initial portion of the payments, produce and complete the products, deliver the products to the consumers. Vendor receives the remaining portion of the fund upon fulfilling the contracts.

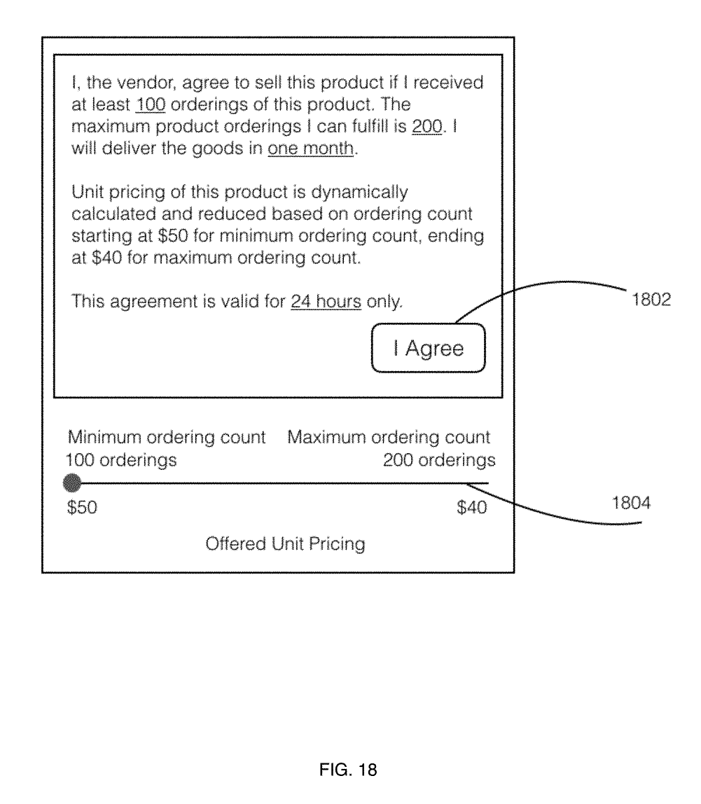

If the product offering is discontinued and/or canceled on said promotional channels (FIG. 10 and FIG. 12), said agreements of purchase from the consumers (FIG. 16), and said agreement of offering said product by the vendor (FIG. 17 and FIG. 18) are canceled, no longer valid. Consumers are not charged for said canceled product offerings.

If the minimum bulk ordering count is not reached within the predefined timeframe (FIG. 12), said agreement of purchase from the consumers (FIG. 16), and said agreement of offering said products by the vendor (FIG. 17 and FIG. 18) become expired after said defined timeframe (for example 24 hours), are no longer valid. Consumers are not charged for said canceled product offerings.

### Section 13 Pricing Adjustment Base on Ordering Count

When the vendor prepares the product offering, he/she need to do a financial analysis and calculate how many product he/she can produce, and what's the minimum unit pricing for said custom made products (FIG. 14).

In general, the more product units that are produced out of the same production process, and the same prototype product, the lower the unit cost of producing each products, the more likely it is for said vendor to make profit out of bulk producing said custom made products.

Therefore, said vendor needs to calculate the cost of producing a batch of products, add with the minimum profit he/she would like to get out of the bulk sale of said products, and calculate the gross sales volume he/she need to reach for said batch of products. He/she then estimate the amount of products he/she can produce and deliver to customer within reasonable timeframe (for example, one month). This creates an upper limit of the product ordering count he/she can fulfill in said product offering (FIG. 13 and FIG. 17).

Said vendor may offer a pricing incentive to increase the amount of ordering for his/her product offering by offering a lower unit pricing for said product at a lager ordering amount 1804 (FIG. 18). Said adjustable pricing is dynamically calculated by said system using the terms said vendor defined in his/her digital contract 1802 1804 (FIG. 18).

This way, the more consumers order said product, the more likely each consumer gets a lower unit pricing for said product. This will incentive the consumers who like said product sharing said product offering with their friends and people in their network, spread out the words, creating viral effect for said product offering. Said sharing and word-of-month, in return, helping said vendor getting more orders for his/her products.

The terms on said pricing adjustment is entered by the vendor on said system (FIG. 18), recorded and agreed upon in the digital contract 1802, offered to consumers with the product offering and digital contract (FIG. 16). Consumers review and choose to agree to said terms by signing the digital contracts on their electronic devices. Said adjusted pricings are calculated by said system and automatically reflected in the final sales price upon the execution of said purchase and sale agreements, and completion of the sale.

Consumers and vendor may choose to use static pricing instead of dynamic and/or adjustable pricing for their digital contracts.

### Section 14 Customized Virtual Auto-Outfit Product Promotion Data Channel

A customized virtual outfit product promotion data channel is a data channel that directly and automatically renders computer generated visual graphical images of new potential products, situated on top of personal photo images of consumers. Said visual graphical image/result is automatically generated by computer and/or electronic devices, based on the images, graphic, data, url links received from said custom offer channel, integrated with pictures and/or photos taken from the camera, and/or uploaded onto said electronic devices, using placeholder, settings, presets and other criteria defined by said consumer. It let consumers visualize how a product fits into their personal environment, and/or how they look like wearing a custom made apparel product, using visual graphical images automatically generated and displayed by computer, requires no or minimum user inputs.

### Section 15 Embodiment of Custom Offer System

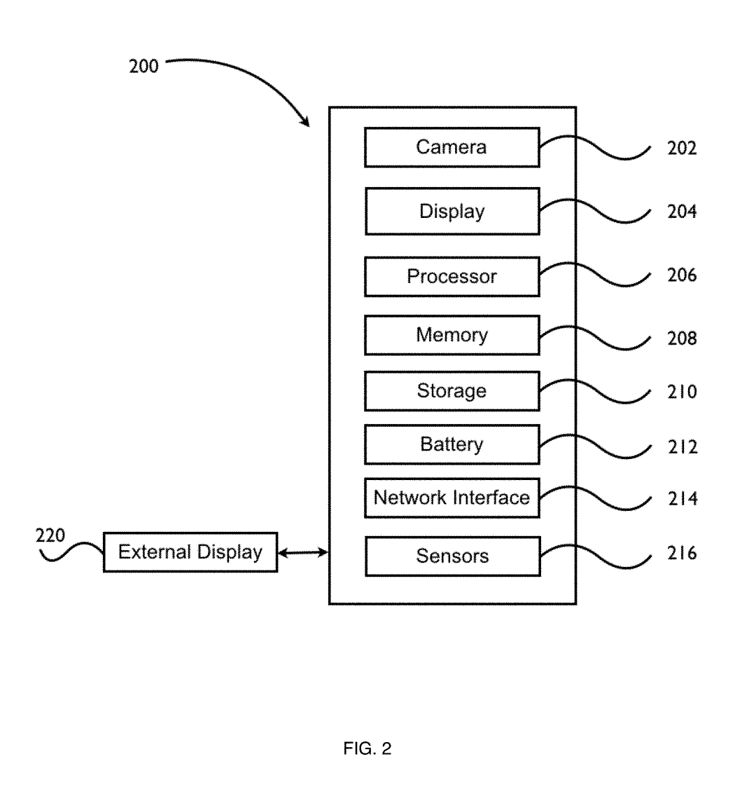

With reference to FIG. 2, an environment for implementing the embodiments described herein includes a custom offer system, such as the one described in FIG. 2. Any and all components of the custom offer system may execute as or on a touch screen mobile device such as a phone or tablet, a touch screen TV with computation capability, a computer system, and/or other possible multi-media devices with computation capability. As such, a basic custom offer system applicable to all these environments is described hereinafter.

In its most basic configuration, custom offer system 200 comprises at least one processing unit or processor 206 and system memory 208, a camera 202, a touch screen display 204. In embodiments, data and images are loaded into memory 208 and executed by the processing unit 206 from system memory 208. Depending on the exact configuration and type of system 200, memory 208 may be volatile (such as RAM), non-volatile (such as ROM, flash memory, etc.), or some combination of the two.

Additionally, custom offer system 200 may also have other components. For example, custom offer system 200 includes additional media storage 210, such as removable and/or non-removable media storage, including, but not limited to, SD memory card, magnetic or optical disks or tape. Custom offer system 200 may have battery 212 to provide power when not connected to an external power source.

Custom offer system 200 may have input component 214 such as graphic drawing pad, mouse, keyboard and etc. The display may be embedded with touch sensors, thus function as a touch screen display 204. The custom offer system 200 may have output component 216, which handles the displays and transfer of both image and data outputs from the custom offer system to other devices and/or systems. Custom offer system 200 may have sensor component(s) 218, such as touch sensor, light sensor, GPS sensor, near field communication sensor and/or etc to handle the sensing, receiving and transferring of data.

Custom offer system 200 can use an external display 220 to provide better visualization result, such external display 220 can be a TV, a projector device and/or etc. The external display 220 may be connected with the custom offer system 200 through wiring or wireless connections including but not limited to Wi-Fi, blue-tooth connection and/or etc.

### Section 16 Example of a Usage

For example, a vendor is skilled at making necklaces. She has a stock of precious stones that can be used for creating said necklaces. Creating a necklace requires making the mold for the parts of said necklace, which consumes substantial percentage of efforts to design and make. Using her expertise and experience, she designs a necklace prototype using computer graphics programs, photos of the materials and her design elements. Base on the resources required to make said necklace, and the profit she would like to gain from selling said necklaces, she calculated that the minimum ordering count needs to be 100 set of necklaces, and the pricing for each set is $200.

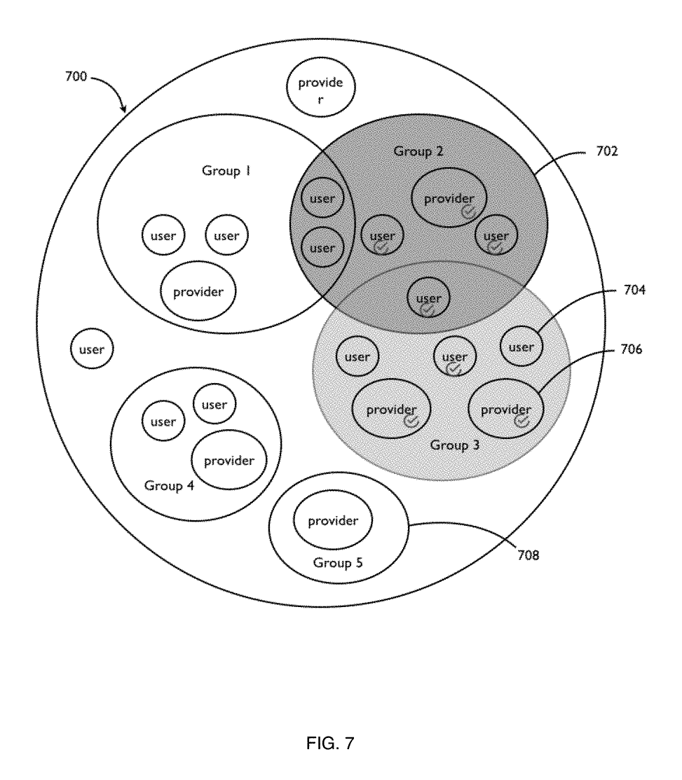

She creates a product offering, included the images of the prototype, description, related data, url links, along with the pricing and term. She distributes said product offering through said custom offer channels of by said system, that have preferences settings tailors for consumers who are interested in buying necklaces (FIG. 7). Within 24 hours, she received 57 pre-orderings of said necklace, along with some consumer feedback that the pricing is too high and design needs to be improved. Since she did not receive enough ordering within the defined timeframe, all pre-orderings are automatically cancelled after reaching the 24 hour timeframe.

Said vendor redesigned the necklace, create another product offering with an improved design and lower pricing. She promote said new product offering through said custom offer channels of said system again on a later day.

This time, in 24 hours, she received 120 orderings of said improved necklace product. Upon reaching the minimum sales count within the defined timeframe, all digital contracts are automatically transferred into sales orders. The consumers who ordered said products receive invoices and make payments. Upon receiving down payment of the orderings, said vendor produce and complete said bulk ordering of necklaces. After she receives the final payments, she delivers the finished products to the consumers.

Consumers also share their ratings and reviews regarding said necklace and said designer on said system, follow and/or un-follow said designer, providing organic peer-review effects.

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

What is claimed is:

1. A system and method for marketing and selling products, through custom offer channels, comprising:
a. a component to display product offerings, images and/or data to user;
b. means for said user to iterate and/or browse through said product offerings; and
c. means for said user to interact with said system and enter user data; and
d. means for said user to sign up to custom offer channels; and
e. means for said user to automatically receive product offerings that fit his/her preferences and/or criteria using said custom offer channels; and
f. means for said user to capture, select and/or load image(s) and/or photo(s) of himself/herself and/or his/her environment using said system; and
g. means for said system to automatically process images and/or data, integrate images of said products into image(s) and/or photo(s) provided by said consumer, generating graphical visual results of said product(s) situating in said user's environment, and/or said user(s) wearing said product(s); and
h. means for said system to supply said user said integrated graphical visual results in an iterative and continuous way using custom offer channels; and
i. means for said user to directly purchase and/or order said products using digital contact(s); and
j. means for said system to simultaneously render said customized, integrated product offerings to a plurality of users at the same time; and
k. means for said system to facilitate and produce bulk sell of said products to plurality of users at the same time.

2. The system and method for marketing and selling products in accordance with claim 1, where in said product offerings, purchases and sales, are handled by digital contracts, consumers and vendors mutually agree to buy and sell said products under a set of defined terms and conditions, and sign digital contracts for said agreement; upon reaching said terms and conditions, the purchases and sales of said products are executed, said transactions of said products are completed according to said terms.

3. The system and method for marketing and selling products in accordance with claim 2, where in a plurality of said transactions are handled by said system at the same time, upon reaching minimum sales count and/or other defined terms and conditions in said agreement, all digital contracts under the same said terms and conditions are executed at the same time, all said purchases and sales of said products are completed at the same time.

4. The system and method for marketing and selling products in accordance with claim 1, where in the promoting frequency of said product offerings are dynamically adjusted base on real-time consumer feedback.

5. The system and method for marketing and selling products in accordance with claim 1, where in timeframes are defined and used for promoting said product offerings.

6. The system and method for marketing and selling products in accordance with claim 1, where in pricing of said products are dynamically adjusted base on real-time consumer feedback and/or amount of orderings of said products.

7. The system and method for marketing and selling products in accordance with claim 1, where in virtual outfitting services are integrated into said system and sell as a free and/or paid service offering(s) on said system, providing visualization of said products situated in said consumer's personal environment, and/or visualization of said consumer wearing said apparel product.

8. The system and method for marketing and selling products in accordance with claim 1, where in sharing and referring mechanism are implemented to encourage users sharing said product offerings.

9. The system and method for marketing and selling products in accordance with claim 1, further comprising initiating means for said user to enter review, comments and feedbacks for products, to communicate with providers, vendors, designers and/or other corresponding parties through said system.

10. The system and method for marketing and selling products in accordance with claim 1, further comprising initiating means for collecting customized design inputs from a plurality of users, process and consolidate the data, and generate reports from the data.

11. The system and method for marketing and selling products in accordance with claim 1, where in said custom product offerings and said graphical visual results are received, stored, processed on said user electronic devices, automatically iterate and display as background wallpaper images and/or screen saver graphical images and/or widgets on said user devices.

12. The system and method for marketing and selling products in accordance with claim 1, further comprising initiating means of using a plurality of configuration templates to configure when, where and how to receive, store, process and display promotional messages received from said custom offer
